(19) United States
(12) Patent Application Publication
(10) Pub. No.: US 2026/0310743 A1
(43) Pub. Date: Oct. 8, 2026

(54) ACCESSIBILITY DATA SELECTION WITH PROMPT CONSTRUCTION

(71) Applicant: Microsoft Technology Licensing, LLC, Redmond, WA (US)

(72) Inventors: Tyler James LEONHARDT, Seattle, WA (US); Deepak MOHAN, Nagano City (JP); Connor PEET, Puyallup, WA (US); Daniel John IMMS, Bothell, WA (US)

(21) Appl. No.: 19/169,051

(22) Filed: Apr. 3, 2025

(51) Int. Cl. G06F 16/958; G06F 16/951; G06F 40/58

(52) U.S. Cl. CPC G06F 16/986; G06F 16/951; G06F 40/58

(57) ABSTRACT

Some embodiments get accessibility information of a web page, and then filter it to include specified context data and to exclude specified non-context data. A version of the context data is provided to a language model in a prompt, or along with a prompt, to influence computation of a response of the language model. In some cases, the provided version includes a markdown language translation of accessibility data extracted from the web page. Some embodiments run a browser script before extracting the accessibility data. In some, a portion of the markdown is chosen, with the choice being based on vector similarity or on association with a link. In some embodiments, links are consolidated.

### BACKGROUND

A language model receives a prompt, performs processing, and produces a response to the prompt. Language model implementations vary, with some examples including statistical language models that use statistical patterns in data to predict the likelihood of a particular word sequence in a potential response, and machine learning language models which use internal weights and biases that are set by training the model on examples of human language or other data. The response from a model depends in part on the prompt given to the model, but also depends on the model's architecture, and how the model was trained. Improvements in language model prompt construction remain possible.

### SUMMARY

Some embodiments address technical challenges arising in efforts to improve language model prompt construction. One challenge is how to improve the effectiveness of the prompt by providing the model with contextual data that steers the model toward a response that is accurate and relevant. Another challenge is how to improve efficiency by reducing or avoiding the processing of prompt content that is less effective. Other technical challenges of identifier creation and use are also addressed herein.

One example embodiment extracts accessibility data by extracting context data (structure data or content data, or both) from accessibility information of a web page. The extracting includes filtering in particular kinds of context data, or filtering out particular kinds of non-context data, or doing both. Some of the examples of context data include: hypertext markup language element role structure data, anchor link structure data, skip-to link structure data, webform placeholder structure data, closed captioning content data, transcript content data, image alternative text description content data, and link name description content data. Some of the examples of non-context data include: style sheet data, text color data, background color data, color contrast data, text style data, text font data, text size data, web page header data, web page footer data, and web page display icon data. Then this example embodiment translates at least a part of the extracted accessibility data into a markdown language text, and supplies at least a portion of the markdown language text to a language model as a prompt context.

Additional technical activities, technical characteristics, and technical benefits pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce-in a simplified form some technical concepts that are further described below in the Detailed Description. Subject matter scope is defined with claims as properly understood, and to the extent this Summary conflicts with the claims, the claims should prevail.

### BRIEF DESCRIPTION OF THE DRAWINGS

A more particular description is given with reference to the attached drawings. These drawings only illustrate selected aspects and thus do not fully determine coverage or scope.

FIG. 1 is a diagram illustrating aspects of computer systems, including some aspects generally suitable for enhanced systems which include or use accessibility data selection with prompt construction (ADSPC) functionality;

FIG. 2 is a block diagram illustrating aspects of a first example family of enhanced systems which are each configured with ADSPC functionality;

FIG. 3 is a dataflow diagram of a second example family of enhanced systems which are each configured with ADSPC functionality;

FIG. 4 is a block diagram illustrating aspects and examples related to accessibility information in a computing system;

FIG. 5 is a block diagram illustrating additional aspects and examples related to ADSPC functionality;

FIG. 6 is a first flowchart illustrating some ADSPC methods;

FIG. 7 is a second flowchart illustrating some ADSPC methods; and

FIG. 8 is a third flowchart further illustrating ADSPC methods, and incorporating as options the steps of each of FIG. 6 and FIG. 7, and other steps disclosed herein.

### DETAILED DESCRIPTION

### Overview

Some teachings described herein reflect technical challenges faced and insights gained during efforts to improve the accuracy and utility of language models which are accessed during software development. However, the teachings herein are not limited in their scope or applicability to this particular kind of language model or particular use of language models, or to the particular challenges, solutions, or insights discussed herein, or to the particular application fields used as examples herein.

In addition to a user query, a language model prompt sometimes includes some context data, or some context data is provided to the language model along with the prompt. For example, a prompt for a user query seeking an example of computer source code in a specified programming language to perform an operation X can be submitted with context data that shows source code to perform an operation Y, or with context data that shows source code to perform operation X in a different programming language, or both. Such context, and other context in other scenarios, often helps steer the language model to produce a response that is more accurate, and that is more useful.

To obtain suitable context, some systems search the internet or another network for web pages. The search is guided, e.g., by keywords from the user's query, and the search leverages the search engine's internal mechanisms that assess the relevance of different web pages. The web pages identified by the search are then given to the language model as context for the prompt.

Although the foregoing approach can provide some relevant context for a prompt, refinements and changes can improve the results. Some embodiments described herein take an approach referred to here as accessibility data selection with prompt construction (ADSPC). These embodiments filter in particular kinds of context data from a web page's accessibility information, or filter out particular kinds of non-context data from the web page's accessibility information, or do both. Then the resulting “extracted” (filtered) data is supplied, in some version, to a language model as prompt context.

ADSPC functionality is not a familiar goal of accessibility information. Accessibility information is information in a web page, explicit or implicit, which makes it easier for challenged persons to perceive the web page's content, to navigate within the web page, or to otherwise interact with the web page, than it would be for them without the accessibility information. For present purposes, a challenged person is a person who (a) meets a legal definition of disability or impairment under law of the relevant jurisdiction, (b) has a physical, mental, intellectual, or sensory impairment that hinders their full and effective interaction with computer systems on an equal basis with others, or (c) has at least one of the following characteristics: blindness, low vision which is not correctable by lenses, color blindness, deafness, or inability to operate a mouse in a graphical user interface. These groups (a), (b), and (c) overlap.

When accessibility information is viewed from a novel perspective of possible use for language model prompt construction, instead of from the typical perspective of assisting a challenged person, the accessibility information includes both context data and non-context data. For instance, some visually challenged persons benefit from web page use of larger text, and from contrasting text and background colors, but these web page data have little or no utility as language model prompt context. Text size data and color data are examples of accessibility information which is non-context data. On the other hand, image alternative descriptions and link descriptions are examples of accessibility information which is context data.

Some ADSPC functionality starts with accessibility information, and then filters it to include context data and to exclude non-context data. Including context data helps improve language model responses, and computational efficiency. Excluding non-context data reduces or avoids the processing of accessibility information that is helpful to assist challenged people interact with web pages but is not particularly helpful to guide a language model.

In some ADSPC embodiments, a computing system performs a method which includes: extracting accessibility data by extracting structure data or content data, or both, from accessibility information of a web page, the extracting comprising filtering such that the extracted accessibility data is free of at least N of: style sheet data, display color data, color contrast data, text style data, text font data, text size data, header data, footer data, or web page display icon data (N being in the range from 1 to the number of items listed); translating at least a part of the extracted accessibility data into a markdown language text; and supplying at least a portion of the markdown language text to a language model as a prompt context.

This ADSPC functionality has a technical benefit of improving language model prompt processing efficiency by avoiding inclusion of non-context data in a prompt while also providing prompt context that steers the language model toward accurate and useful responses. In particular, non-context data does not consume as many tokens within a prompt as it would have if not filtered out by the embodiment. This ADSPC functionality also has a technical benefit of improving language model efficiency and accuracy by providing the prompt context as markdown language text, which is more efficiently and effectively processed by the language model than web page hypertext markup language (HTML), for example.

In some ADSPC embodiments, the computing system includes a web browser and a script in the web browser, and the method further includes altering or creating accessibility data by running the script prior to the extracting. This ADSPC functionality has a technical benefit of giving the prompt construction process access to context data that is not explicit in the web page HTML but is nonetheless related to the web page and is therefore likely to help steer the language model to better responses.

In some ADSPC embodiments, the translating includes mapping a hypertext markup language element role structure data to a markdown component. This ADSPC functionality has a technical benefit of improving language model efficiency and accuracy by providing the prompt context as markdown language text, which is more efficiently and effectively processed by the language model than HTML, for example.

In some ADSPC embodiments, the extracting includes reading a hidden text of the web page. This ADSPC functionality has a technical benefit of giving the prompt construction process access to context data that is not visible on the rendered web page but sometimes includes textual data such as image alternative descriptions and link descriptions that is likely to help steer the language model to better responses.

In some ADSPC embodiments, the method includes choosing the portion of the markdown language text, and the choosing includes performing a vector similarity comparison of a markdown vector which is derived from the markdown language text to a user query vector which is derived from a user query, and choosing in response to a result of the vector similarity comparison. This ADSPC functionality has a technical benefit of further refining and focusing the context data, thereby increasing the likelihood that the prompt context will steer the language model to better (more accurate, more useful) responses to the user query.

In some ADSPC embodiments, the extracting includes filtering such that the extracted accessibility data includes at least N of: heading structure data, heading content data, hypertext markup language element role structure data, hypertext markup language landmark structure data, hypertext markup language element semantic structure data, anchor link structure data, skip-to content link structure data, webform placeholder structure data, closed captioning content data, video transcript content data, audio transcript content data, image alternative text description content data, link name description content data, image content data, or form label content data (N being in the range from 1 to the number of items listed). This ADSPC functionality has a technical benefit of improving language model prompt processing efficiency by avoiding inclusion of non-context data in a prompt while also providing prompt context that steers the language model toward accurate and useful responses. In particular, non-context data does not consume as many tokens within a prompt as it would if not filtered out by the embodiment.

These and other advantages and benefits will be apparent to one of skill from the teachings provided herein.

### Operating Environments

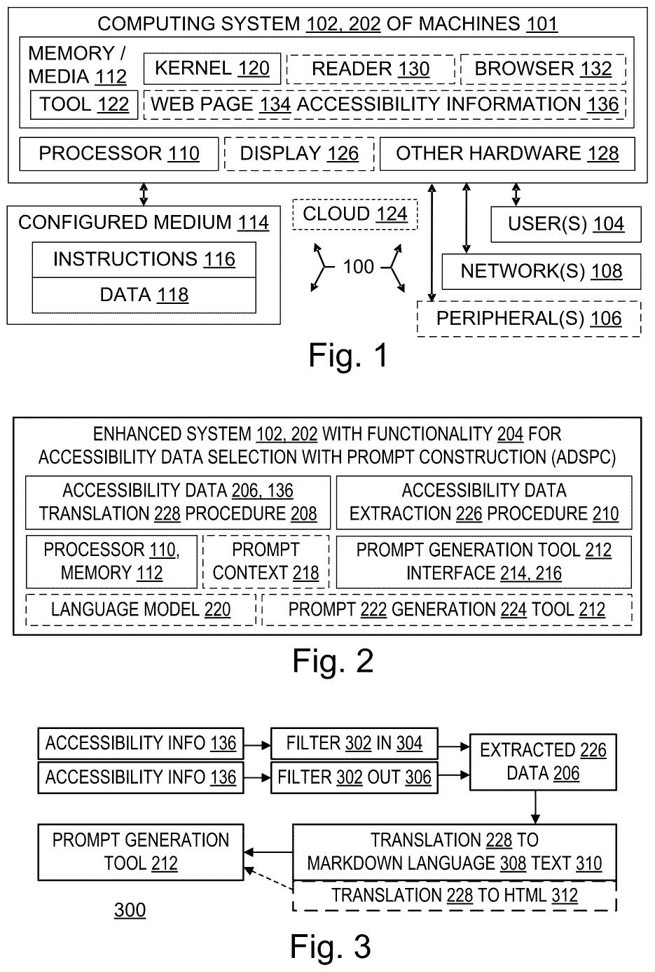

With reference to FIG. 1, an operating environment 100 for an example embodiment includes at least one computer system 102. The computer system 102 may be a multiprocessor computer system, or not. An operating environment may include one or more electrically-powered machines 101 in a given computer system, which may be clustered, client-server networked, and/or peer-to-peer networked within a cloud 124. An individual machine 101 which includes a processor 110 and a digital memory 112 is a computer system, and a network or other non-empty cooperating group of such machines 101 is also a computer system. A given computer system 102 may be configured for end-users, e.g., with applications, for administrators, as a server, as a distributed processing node, and/or in other ways.

System administrators, network administrators, cloud administrators, security analysts and other security personnel, operations personnel, developers, testers, engineers, auditors, and end-users are each a particular type of human user 104. Human users 104 sometimes interact with a computer system 102 user interface by using displays 126, keyboards 106, and other peripherals 106, via typed text, touch, voice, movement, computer vision, gestures, and/or other forms of I/O (input/output). Virtual reality or augmented reality or both functionalities are provided by a system 102 in some embodiments. A screen 126 is a removable peripheral 106 in some embodiments and is an integral part of the system 102 in some embodiments. The user interface supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

Storage devices or networking devices or both are considered peripheral equipment 106 in some embodiments and integral parts of a system 102 in other embodiments, depending on their physical detachability from an electrical connection to the processor 110 hardware. In some embodiments, other computer systems not shown in FIG. 1 interact in technological ways with the computer system 102 or with another system embodiment using one or more connections to a cloud 124 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software applications, editors, compilers, debuggers and other software development tools, document processing tools, as well as APIs, browsers, or webpages and the corresponding software for protocols such as HTTPS. Files, APIs, endpoints, and other resources may be accessed by an account or non-empty set of accounts, user or non-empty group of users, IP address or non-empty group of IP addresses, or other computational entity.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system 102 when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks (solid state or magnetic or optical), and other memory storage devices which are not readily removable by users 104. For compliance with current United States patent requirements, neither a computer-readable medium nor a computer-readable storage medium nor a computer-readable memory nor a computer-readable storage device is a signal per se or mere energy under any claim pending or granted in the United States.

A storage device 114 is sometimes configured with binary instructions 116 that are executable by a processor 110; “executable” is used in a broad sense herein to include machine code, interpretable code, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, physical measurements, sensor data, and so forth.

Although an embodiment may include software instructions executed by one or more processors in a computing device, such description is not meant to exhaust all possible embodiments. Embodiments do not necessarily include any software. One of skill will understand that the same or similar functionality of software can often be implemented, in whole or in part, directly in hardware logic, to provide the same or similar technical effects. Alternatively, or in addition to a software implementation, technical functionality can be performed, in some examples, by one or more hardware logic components. For example, and without excluding other implementations, some embodiments include one or more of: chiplets, hardware logic components 110, 128 such as Field-Programmable Gate Arrays (FPGAs), Application-Specific Integrated Circuits (ASICs), Application-Specific Standard Products (ASSPs), System-on-a-Chip (SoC) components, Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUs, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) are present in operable communication with one or more processors 110 and memory 112.

In some embodiments or operating environments, a system includes multiple computers connected by a wired and/or wireless network 108. Networking interface equipment 128 provides access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments or operating environments, one or more computers are partially or fully “air gapped” by reason of being disconnected from, or only intermittently connected to, another networked device or remote cloud or the internet. Some examples also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some example embodiments, but are not required in every embodiment. This document's headings do not provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current disclosure.

In any later application that claims priority to the current application, reference numerals may be properly added to designate items disclosed in the current application. Such items may include, e.g., software, hardware, steps, processes, systems, functionalities, mechanisms, connections, devices, data structures, kinds of data, settings, parameters, components, computational resources, workflows, or algorithm implementations, or other items in a computing environment, which are disclosed herein but not tied to a particular reference numeral. Corresponding drawings may also be properly added.

More about ADSPC Systems

Specific items called out in the figures are discussed at various points herein. FIG. 2 illustrates a computing system 102 or other system configured by one or more of the ADSPC functionality enhancements taught herein, resulting in an enhanced system 202. In some embodiments, an enhanced system 202 includes a single machine, a local network of machines, machines in a particular building, machines used by a particular entity, machines in a particular datacenter, machines in a particular cloud, or another environment 100 that is suitably enhanced as taught herein.

FIG. 3 is a dataflow diagram 300 of another example family of enhanced systems 202 which are each configured with ADSPC functionality 204. In some embodiments consistent with FIG. 3, components shown in FIG. 2 or other figures are also present.

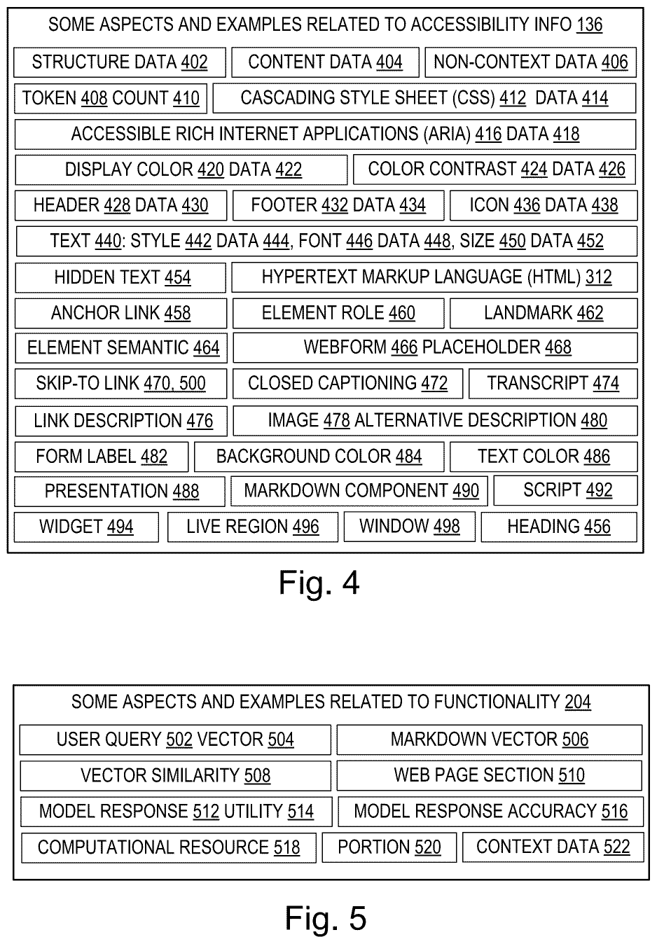

FIGS. 1-5 show reference numerals for some items and some aspects of items that relate to ADSPC. Failure to receive a reference numeral does not make an item insignificant. FIGS. 1-5 do not individually or collectively or in any subset fully define a comprehensive summary of all aspects of enhanced systems 202 or all aspects of ADSPC functionality 204. Nor is any figure of FIGS. 1-5 or any group of figures of FIGS. 1-5 by itself a comprehensive summary of all aspects of an environment 100 or another computational context of an enhanced system 202.

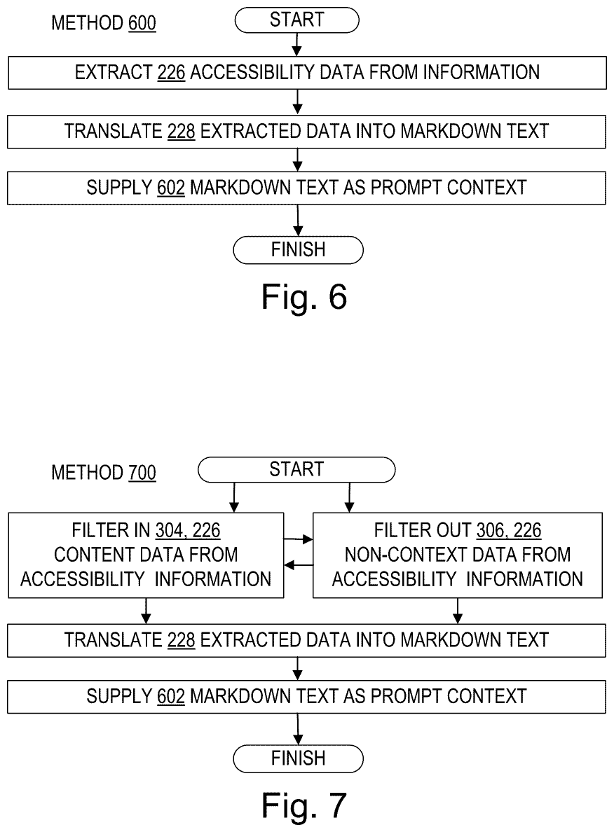

The other figures are also pertinent to systems 202. FIGS. 6 to 8 are flowcharts which illustrate some methods of ADSPC functionality 204 operation in some systems 202.

In some embodiments, the enhanced system 202 is networked through an interface 216. In some, an interface 216 includes hardware such as network interface cards, software such as network stacks, APIs, or sockets, combination items such as network connections, or a combination thereof.

Some embodiments include a computing system 202 which is equipped, structured, or otherwise configured to utilize or provide ADSPC functionality 204. The system 202 includes a digital memory set 112 including at least one digital memory 112, and a processor set 110 including at least one processor 110. The processor set is in operable communication with the digital memory set. A digital memory set is a set which includes at least one digital memory 112, also referred to as a memory 112. The word “digital” is used to emphasize that the memory 112 is part of a computing system 102, not a human person's memory. The word “set” is used to emphasize that the memory 112 is not necessarily in a single contiguous address block or of a single kind, e.g., a memory 112 may include hard drive memory as well as volatile RAM, and may include memories that are physically located on different machines 101, but “memory” alone also includes systems with multiple memories. Similarly, the phrase “processor set” is used to emphasize that a processor 110 is not necessarily confined to a single chip or a single machine 101, but “processor” alone also includes systems with multiple processors.

All sets herein are non-empty unless described otherwise. At a given point in time any data structure implementing a set identified in this description is empty, or is non-empty, depending on the embodiment and the circumstances. However, even an empty set is defined and detectable in the system 202 as a set when an embodiment includes a data structure implementing the set. The absence of members of a set is not the absence of the set itself.

In this example, a computing system 202 includes at least one processor 110, which is in operable communication with at least one digital memory 112. The at least one digital memory includes volatile storage and non-volatile storage unless indicated otherwise.

Some embodiments include a computing system 202 including: a digital memory 112; a processor 110 in operable communication with the digital memory; an accessibility data extraction procedure 210 which includes instructions 116 which upon execution by the processor extracts 226 accessibility data 206 by extracting 226 structure data 402 or content data 404, or both, from accessibility information 136 of a web page 134, the extracting including filtering 302, 306 such that the extracted accessibility data is free of at least N of: style sheet 412 data 414, display color 420 data 422, color contrast 424 data 426, text 440 style 442 data 444, text font 446 data 448, text size 450 data 452, web page header 428 data 430, web page footer 432 data 434, or web page display icon data 438; an accessibility data translation procedure 208 which includes instructions 116 which upon execution by the processor translates 228 at least a part of the extracted accessibility data into a markdown language 308 text 310; and an interface 214 (e.g., API, user interface, other programmatic interface) to a language model 220 prompt 222 generation 224 tool 212, the interface configured to receive at least a portion of the markdown language text.

In a variation, the accessibility data extraction procedure 210 which includes instructions 116 which upon execution by the processor extracts 226 accessibility data 206 by extracting 226 structure data 402 or content data 404, or both, from accessibility information 136 of a web page 134, the extracting including filtering 302, 306 such that the extracted accessibility data is free of text color data 486, 422 and free of background color data 484 422.

In some embodiments, the accessibility data extraction procedure 210 includes instructions which upon execution by the processor filter 302, 304 data such that the extracted accessibility data includes at least N of: heading 456 structure data 402, heading 456 content data 404, hypertext markup language element role 460 structure data 402, hypertext markup language landmark 462 structure data 402, hypertext markup language element semantic 464 structure data 402, anchor link 458 structure data 402, skip-to content 470 link structure data 402, webform 466 placeholder 468 structure data 402, closed captioning 472 content data 404, video transcript 474 content data 404, audio transcript 474 content data 404, image 478 alternative text description 480 content data 404, link 500 name description 476 content data 404, image 478 content data 404, or form 466 label 482 content data 404 (N being in the range from 1 to the number of items listed).

In this and some other embodiments, some items 418 are listed which are defined within, or are consistent with, same-named items or otherwise unambiguously referenced items, in at least one version of the Web Accessibility Initiative accessible rich internet applications (ARIA) 416 specification, including working drafts, which was public as of the priority date of the present disclosure.

In some embodiments, the accessibility data extraction procedure 210 includes instructions which upon execution by the processor check 808 for and filter out 306 at least N of: hypertext markup language element role structure data of a presentation 488 role 460, 418, hypertext markup language element role 460, 418 structure data of a widget 494 role, hypertext markup language element role 460, 418 structure data of a live region 496 role, or hypertext markup language element role 460, 418 structure data of a window 498 role (N being in the range from 1 to the number of items listed).

In some embodiments, the accessibility data translation procedure 208 includes instructions which upon execution by the processor map 818 at least one of the following hypertext markup language element role 460 structure data 402 to a markdown component 490: heading 456, paragraph 822, list 824, link 500, image 478, blockquote 830, code 832, mathematical equation 820, or table 834.

For example, some embodiments perform 818 such a mapping by executing software code 116 along the following lines:

```
switch (role) {
case ′heading′:
  processHeadingNode(node, buffer, depth);
  return;
case ′paragraph′:
  processParagraphNode(node, buffer, depth);
  return;
case ′list′:
  processListNode(node, buffer, depth);
  return;
case ′link′:
  if (!isNavigationLink(node)) {
    const linkText = getNodeText(node.node);
    const url = getLinkUrl(node.node);
    buffer.push(‘[${linkText}](${url})‘);
  }
  return;
case ′image′: {
  const altText = getNodeText(node.node) ∥ ′Image′;
  const imageUrl = getImageUrl(node.node);
  if (imageUrl) {
    buffer.push(‘![${altText}](${imageUrl})\n\n‘);
  } else {
    buffer.push(‘[Image: ${altText}]\n\n‘);
  }
  break;
}
case ′blockquote′:
  buffer.push(′> ′ + getNodeText(node.node).replace(/\n/g, ′\n> ′) + ′\n\n′);
  break;
case ′code′: {
  processCodeNode(node, buffer, depth);
  return;
}
case ′table′:
  processTableNode(node, buffer);
  return;
  // More roles...
}
```

Following is an example of the heading implementation which looks at what level is set in accessibility information and will build a string that looks like ## Hello, for example. AXNodeTree is a tree data structure containing nodes which represent accessibility information:

```
function processHeadingNode(node: AXNodeTree, buffer: string[ ], depth:
number): void {
  buffer.push(′\n′);
  const level = getHeadingLevel(node.node);
  buffer.push(‘${′#′.repeat(level)} ‘);
  // Process children nodes of the heading
  for (const child of node.children) {
    if (getNodeRole(child.node) === ′StaticText′) {
      buffer.push(getNodeText(child.node));
    } else {
      processNode(child, buffer, depth + 1);
    }
  }
  buffer.push(′\n\n′);
}
```

In some embodiments, the accessibility data extraction procedure 210 includes instructions 116 which upon execution by the processor check for 808 and filter out 306 style sheet data.

In some embodiments, the accessibility data extraction procedure 210 includes instructions 116 which upon execution by the processor check for 808 and filter out 306 each of: text color data, and background color data.

In some embodiments, the accessibility data extraction procedure 210 includes instructions 116 which upon execution by the processor check for 808 and filter out 306 each of: text style data, text font data, and text size data.

In some embodiments, the accessibility data extraction procedure 210 includes instructions 116 which upon execution by the processor check for 808 and filter out 306 each of: header data, and footer data.

In some embodiments, the accessibility data extraction procedure 210 includes instructions 116 which upon execution by the processor check for 808 and filter out 306 web page display icon data, sometimes referred to as a favicon.

ADSPC Processes (a.k.a. Methods)

Processes (which are also referred to as “methods” in the legal sense of that word) are illustrated in various ways herein, both in text and in drawing figures. FIGS. 6 to 8 each illustrate a family of ADSPC methods 600, 700, and 800 respectively, which are performed or assisted by some enhanced systems, such as some systems 202 or another functionality enhanced system as taught herein. Method families 600 and 700 are each a proper subset of method family 800. Moreover, activities are identified in FIGS. 1 to 5 as explicit or implicit method steps are likewise incorporated into method 800, e.g., constructing a prompt 222, tokenizing the prompt 222, searching to identify the web page 134, parsing a web page 134 to locate accessibility information 136, communicating with a screen reader 130 or a client URL tool 122 in order to receive accessibility information 136, utilizing the response from the language model 220 in some technical manner, and so on. Steps are options which vary among embodiments, e.g., accessibility information 136 can be obtained 226 in one or more of at least four ways (parse HTML 312, use 852 screen reader 130, 122, use 852 a browser 132 reader mode, use 852 curl tool 122, or use a browser development tool API 122). Also, steps that are not expressly tied herein to a particular reference number are not thereby excluded from method 800. These diagrams and flowcharts are merely examples; as noted elsewhere, any operable combination of steps that are disclosed herein may be part of a given embodiment when called out in a claim.

Technical processes shown in the Figures or otherwise disclosed are performed automatically, e.g., by an enhanced system 202, unless otherwise indicated. Related non-claimed processes may also be performed in part automatically and in part manually to the extent action by a human person is implicated, e.g., in some situations a human 104 types text into a user interface. Regardless, no process contemplated as an embodiment herein is entirely manual or purely mental; none of the claimed processes can be performed solely in a human mind or on paper. Any claim interpretation to the contrary is squarely at odds with the present disclosure.

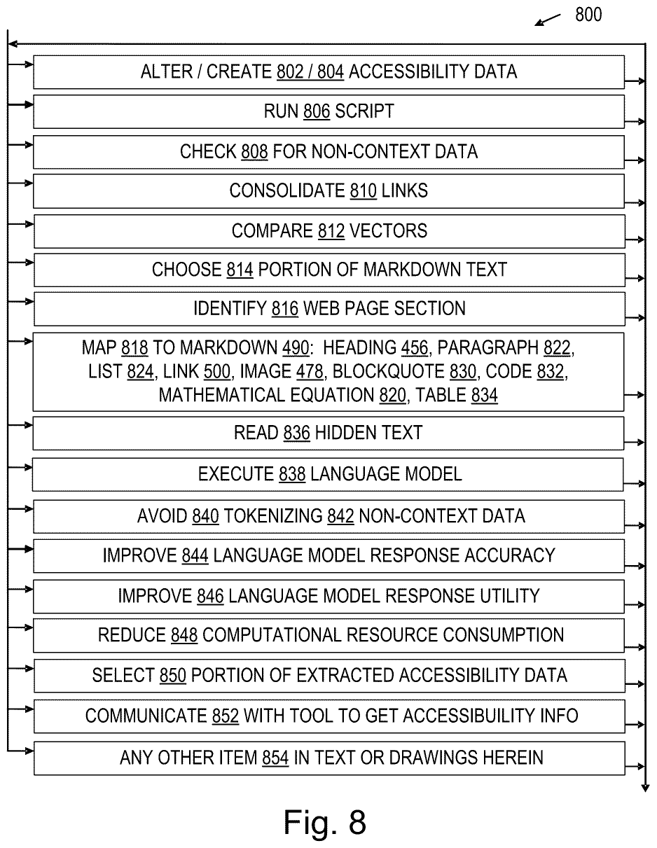

In a given embodiment zero or more illustrated steps of a process may be repeated, perhaps with different parameters or data to operate on. Steps in an embodiment may also be done in a different order than the top-to-bottom order that is laid out in FIG. 8. FIG. 8 supplements the textual and figure drawing examples of embodiments provided herein and the descriptions of embodiments provided herein. In the event of any alleged inconsistency, lack of clarity, or excessive breadth due to an interpretation of FIG. 8, the content of this disclosure shall prevail over that interpretation of FIG. 8.

Arrows in process or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 800 action items are traversed to indicate the steps performed during a process may vary from one performance instance of the process to another performance instance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 8 to be non-operable, the sequence S is not within the scope of any claim. Any assertion otherwise is contrary to the present disclosure.

Some embodiments provide or utilize an ADSPC method 800 which is performed by a computing system. The method includes: extracting 226 accessibility data by extracting structure data or content data, or both, from accessibility information of a web page, the extracting including filtering 302 such that the extracted accessibility data is free of at least N of (N being in the range from 1 to the number of items listed): style sheet data, display color data, color contrast data, text style data, text font data, text size data, header data, footer data, or web page display icon 436 data; translating 228 at least a selected 850 part of the extracted accessibility data into a markdown language text; and supplying 602 at least a portion 520 of the markdown language text to a language model as a prompt context 218 (e.g., via an API).

In some embodiments the method includes: extracting 226 accessibility data by extracting structure data or content data, or both, from accessibility information of a web page, the extracting including filtering 302 such that the extracted accessibility data is free of text display data 406 which specifies a visual display characteristic of a text string 440; translating 228 at least a part of the extracted accessibility data into a markdown language text; and supplying 602 at least a portion of the markdown language text to a language model as a prompt context. Some examples of visual display characteristics include size 450 on a screen 126, color 420 on a screen 126, position on a screen 126, and rotational orientation on a screen 126. Data such as the ASCII, Unicode, or UTF values or characters in the text string are not visual display characteristics.

In some embodiments, the computing system includes a web browser and a script in the web browser, and the method further includes: altering 802 or creating 804 accessibility data by running 806 the script prior to the extracting. This may include, e.g., running (or allowing to run) a JavaScript® script (mark of Oracle America, Inc.). Such scripts sometimes run when a web page is rendered, and sometimes manipulate the web page's content and structure.

In some embodiments, the translating 228 includes mapping 818 a hypertext markup language element role structure data to a markdown component.

In some embodiments, the translating 228 includes consolidating 810 multiple links 500 into a single link 500.

In some embodiments, the extracting 226 includes reading 836 a hidden text 454 of the web page. In some scenarios, a web page hidden text provides an embodiment with additional useful context.

In some embodiments, the extracting 226 includes filtering 302 such that the extracted accessibility data is free of at least N of (N being in the range from 1 to the number of items listed): style sheet data, display color data, color contrast data, text style data, text font data, text size data, header data, footer data, or web page display icon data.

In some embodiments, the method includes choosing 814 the portion of the markdown language text, and the choosing includes performing 812 a vector similarity comparison of a markdown vector 506 which is derived from the markdown language text to a user query vector 504 which is derived from a user query 502, and choosing in response to a result of the vector similarity comparison.

In some embodiments, the method includes choosing 814 the portion of the markdown language text, and the choosing includes identifying 816 a section 510 of the web page which is associated with an anchor link or a skip-to link, and choosing markdown language text which corresponds to the identified section.

In some embodiments, the extracting includes filtering 302 such that the extracted accessibility data includes at least N of (N being in the range from 1 to the number of items listed): heading structure data, heading content data, hypertext markup language element role structure data, hypertext markup language landmark structure data, hypertext markup language element semantic structure data, anchor link structure data, skip-to content link structure data, webform placeholder structure data, closed captioning content data, video transcript content data, audio transcript content data, image alternative text description content data, link name description content data, image content data, or form label content data.

### ADSPC Configured Storage Media

Some embodiments include a configured computer-readable storage medium 112. Some examples of storage medium 112 include disks (magnetic, optical, or otherwise), RAM (random access memory), EEPROMs (electronically erasable read-only memories) or other ROMs (read-only memories), and other configurable memory, including in particular computer-readable storage media (which are not mere propagated signals). In some embodiments, the storage medium which is configured is in particular a removable storage medium 114 such as a CD, DVD, or flash memory. A general-purpose memory, which is removable or not, and is volatile or not, depending on the embodiment, is configured in the embodiment using items in the form of data 118 and instructions 116, read from a removable storage medium 114 and/or another source such as a network connection, to form a configured storage medium. The foregoing examples are not necessarily mutually exclusive of one another.

The configured storage medium 112 is capable of causing a computer system 202 to perform technical process steps for providing or utilizing ADSPC functionality 204 as disclosed herein. The Figures thus help illustrate configured storage media embodiments and process (a.k.a. method) embodiments, as well as system and process embodiments. In particular, any of the method steps illustrated in FIG. 3 or FIGS. 6 to 8, or otherwise taught herein, may be used to help configure a storage medium to form a configured storage medium embodiment.

Some embodiments use or provide a computer-readable storage device (a.k.a. medium) 112, 114 configured with data 118 and instructions 116 which upon execution by a processor 110 cause a computing system 202 to perform an ADSPC method 800. This method 800 includes: extracting 226 accessibility data by extracting structure data or content data, or both, from accessibility information of a web page, the extracting including filtering 302 such that the extracted accessibility data is free of at least N of (N being in the range from 1 to the number of items listed): style sheet data, text color data, background color data, text style data, text font data, text size data, footer data, or web page display icon data; translating 228 at least a part of the extracted accessibility data into a markdown language text; and supplying 602 at least a portion of the markdown language text to a language model as a prompt context.

In a variation, extracting accessibility data by includes filtering such that the extracted accessibility data is free of text color data 486, 422 and free of text font data 448.

In some embodiments, the translating 228 includes mapping 818 a hypertext markup language element role structure data to a markdown component.

In some embodiments, the translating 228 includes consolidating 810 multiple links into a single link. For example, some embodiments consolidate links within headers, navbars and footers into a single reference link. The consolidation simplifies page content, making it easier for the language model to interpret the prompt context 218 correctly.

In some embodiments, the extracting 226 includes getting 852 a version of accessibility data from a screen reader assistive technology mechanism 130, and then filtering 302 the version of accessibility data by checking for 808 and filtering out 306 at least N of (N being in the range from 1 to the number of items listed): style sheet data, text color 486 data, background color 484 data, text style data, text font data, text size data, footer data, or web page display icon data.

In some embodiments, the extracting 226 includes getting 852 a version of accessibility data from a client uniform resource locator tool 122 (e.g., cURL tool 122), and then filtering 302 the version of accessibility data by checking for 808 and filtering out 306 at least N of (N being in the range from 1 to the number of items listed): style sheet data, text color data, background color data, text style data, text font data, text size data, footer data, or web page display icon data. Some embodiments filter out advertisements as being non-context data.

### Machine Learning Models, Including Language Models

Some examples of models 220 include large language models (LLMs), small language models (SLMs), large action models (LAMs), small action models (SAMs), multimodal language models, multimodal action models, and foundation models (a term which has multiple meanings in the industry that do, however, overlap the definitions herein). A language model 220 is trained on tokens 408 representing at least natural language or programming language. A multimodal model accepts as input, or produces as output, or both, multiple modes of data, e.g., data representing written language, still images, video (e.g., photographed or animated or mixed) clips, audio (including direct voice input in some, and audio clip input or output), music, sensor telemetry, augmented reality, or other modes. Some multimodal models encode different modes separately, while others encode multiple modes of input data together, e.g., vision and text. Some merge modes, some utilize cross attention across modes.

Many models 220, but not all, utilize a transformer architecture internally, e.g., in decoders or in paired encoder-decoder architectures. One exception is a Vision-Mamba model, a vision tasks model that utilizes an alternate internal architecture of repeated Mamba blocks interleaved with standard normalization layers and residual connections.

Some models 220 utilize multi-token prediction internally, e.g., through an architecture having a shared model trunk with multiple independent output heads, and training to predict multiple future tokens at once using, e.g., self-speculation. Multi-token prediction can provide improved sample efficiency and faster inference than single-token prediction, giving significant gains in generative benchmarks, e.g., for source code generation tasks.

In some embodiments a model 220 employs chain-of-thought reasoning, a technique which prompts the model to output a sequence of intermediate steps to accomplish a task. In some scenarios, this technique improves the model's reasoning abilities by allowing the model to focus on solving one subtask at a time rather than the entire task problem all at once. This technique sometimes allows the model to solve problems that are otherwise not feasible for that model, and also enhances the interpretability of the model's output by showing how the model arrived at the problem solution.

Model context size 410 limits vary, from early model limits of 4K tokens to the present size of at least 128K in many models, and even greater sizes in some at a cost of reduced attention.

A language model 220 within or utilized by an enhanced system 202 is not necessarily a large language model (LLM) in every embodiment, but it is an LLM in some embodiments. For present purposes, a language model is “large” if it has at least a billion parameters. For example, GPT-2 (OpenAI), MegatronLM (NVIDIA), T5 (Google), Turing-NLG (Microsoft), GPT-3 (OpenAI), GPT-3.5 (OpenAI), GPT-4 (OpenAI), and LLaMA versions (Meta AI) are each a large language model (LLM) for purposes of the present disclosure, regardless of any definitions to the contrary that may be present in the industry.

Some additional examples of models 220 one of skill will consider suitable for a given embodiment include Phi-3 (Microsoft), GPT4o (OpenAI), Gemini Pro 1.5 (Google), Gemma (Google), Claude (Anthropic), Command (Cohere), Falcon 180B (Technology Innovation Institute), DBRX (Databricks and Mosaic), and Mistral variants (Mistral). Actual inclusion or use by an embodiment depends on technical factors such as the computing requirements of the intended deployment device relative to the desired model performance, and whether multimodality is required.

Model stability is a consideration in some embodiments and some scenarios. Instability leads to inconsistency in model responses to prompts. Model stability is sometimes dependent on model parameters. Some different models have different stability parameters, and some exhibit different variability between answers to the same question even while using the same stability parameters. Some models 220 are stabilized by adjusting parameters such as temperature, frequency penalty, presence penalty, or nucleus sampling, and also or instead by constraining the queries sent to a given instance of the model.

Small models often provide more deployment flexibility, being able to run on edge devices such as user devices when a large model would require greater computing power or memory or both than is available on the edge device, at least for acceptable performance. One measure of acceptable performance in some embodiments is to provide human interaction with acceptable performance, e.g., user interface responses in under 5 seconds for most prompts other than clip generation prompts. However, small models typically have less recall than large models, making them more suitable for narrower fields of use than large models which can perform well with a larger range of tasks.

In some scenarios, model performance is optimized by use of suitable training data, fine-tuning, prompt engineering, or a combination thereof. In some scenarios part or all of the training data is synthesized data. Microsoft ORCA, for example, focuses automated pipelines to create high-quality synthesized data for training models for specialization and model self-improvement. More generally, training is accomplished using supervised learning or semi-supervised learning, to the extent labeled data is available and effective, but some scenarios rely at least in part on unsupervised learning.

Model performance is enhanced in some embodiments by retrieval augmented generation, by filtering inputs or outputs or both for toxic material or off-topic material, and/or by other quality control mechanisms.

### Additional Observations on ADSPC

Support for the discussion of ADSPC functionality 204 herein is provided under various headings. However, it is all intended to be understood as an integrated and integral part of the present disclosure's discussion of the contemplated embodiments. This disclosure is meant to be understood as a whole. In particular, this disclosure is unlikely to be fully and properly understood during or after only a single top-to-bottom pass through its text. For a full and proper understanding, most if not all readers will also use keyword searches, reference numeral searches, correlation of the specification text with the drawing figures, correlation of the claims with the rest of the text and with the drawing figures, and other nonlinear reading approaches, in addition to reading the full text from top to bottom.

One of skill will recognize that not every part of this disclosure, or any particular details therein, are necessarily required to satisfy legal criteria such as enablement, written description, best mode, novelty, nonobviousness, adequate claim support via technical teachings in the description, inventive step, or industrial applicability. Any apparent conflict with any other patent disclosure, even from the owner of the present subject matter, or any reference external to the present disclosure, has no role in interpreting the claims presented in this patent disclosure. It is in the context of this understanding, which pertains to all parts of the present disclosure, that examples and observations are offered herein.

Some embodiments improve language model responses by translating web page accessibility information into markdown. Some language models, like those used in products such as software development artificial intelligence-based (AI-based) assistants, rely on context to provide accurate and useful responses to user questions. Sometimes, prompt context which includes up-to-date information fetched from the internet (documentation, blog posts, etc.) is very helpful (or even necessary) in order for the language model to respond correctly.

Some integrated development environments 122 have an AI coding assistant integration that would benefit from such prompt context. In some scenarios, the integrated development environment (IDE) is able to load web pages in the background and acquire the accessibility information of the page, which sometimes provides a hierarchy indicating what the page looks like. That said, the LLM (Large Language Model) used in some IDEs responds better when using a less cluttered text format than HTML, such as the Markdown language.

In some embodiments, turn selected data of the accessibility information of the page into Markdown allows an embodiment to provide a simpler and more focused representation of the original web page in a format easily digestible by an LLM so that it can respond with higher accuracy. Also, filtering out non-context data of the page (e.g., navigational elements, headers, footers) allows the embodiment to focus the LLM on what is most important, namely, the main content of the page.

### Internet of Things

In some embodiments, the system 202 is, or includes, an embedded system such as an Internet of Things system. “IoT” or “Internet of Things” means any networked collection of addressable embedded computing or data generation or actuator nodes. An individual node is referred to as an internet of things device 101 or IoT device 101 or internet of things system 102 or IoT system 102. Such nodes are examples of computer systems 102 as defined herein, and may include or be referred to as a “smart” device, “endpoint”, “chip”, “label”, or “tag”, for example, and IoT may be referred to as a “cyber-physical system”. In the phrase “embedded system” the embedding referred to is the embedding a processor and memory in a device, not the embedding of debug script in source code.

IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage—RAM chips or ROM chips provide the only local memory; (e) no CD or DVD drive; (f) being embedded in a household appliance or household fixture; (g) being embedded in an implanted or wearable medical device; (h) being embedded in a vehicle; (i) being embedded in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP (Transmission Control Protocol/Internet Protocol), Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

### Technical Character

The technical character of embodiments described herein will be apparent to one of ordinary skill in the art, and will also be apparent in several ways to a wide range of attentive readers.

For example, some embodiments address technical activities such as extracting context data from accessibility information without employing human senses or human actions, translating extracted data without employing human senses or human actions, constructing a language model prompt without employing human senses or human actions, filtering data without employing human senses or human actions, comparing vectors without employing human senses or human actions, and many others, which are each an activity deeply rooted in computing technology. The “without employing human senses” and “without employing human actions” qualifiers are stated here explicitly to help prevent misunderstanding by some readers, but they would be understood by one of skill in the art as inherent to the embodiments. These qualifiers shall govern the interpretation of the claims even when not explicitly recited in the claims. To improve readability and reduce disclosure length, these qualifiers are not explicitly repeated throughout this disclosure, but the disclosure should be read as if they were thus repeated.

Moreover, some of the technical mechanisms discussed in this disclosure include, e.g., extraction procedures 210, translation procedures 208, prompt generation tools 212, language models 220, and various interfaces 216. None of these are mental concepts or present merely on paper.

In addition, some of the technical effects discussed include, e.g., avoiding 840 tokenizing 842 non-context data, improving 844 language model response accuracy 516, improving 846 language model response utility 514, and reducing 848 computational resource 518 (memory, processing cycles, bandwidth, electric power) consumption, relative to other approaches. Other technical effects are also discussed herein, e.g., in the descriptions of technical benefits and technical challenges.

In short, purely mental processes, activities limited to pen-and-paper, and abstract ideas per se are clearly excluded from the scope of any claimed embodiment. Other advantages based on the technical characteristics of the teachings will also be apparent to one of skill from the description provided.

One of skill understands that the operations performed by functionality 204, and other computational activities described herein are each a technical activity which cannot be performed mentally at all, because the mechanisms in question lack I/O devices that would allow a human to somehow “read” or “write” values within the computing system as described. Hence, computing technology operational improvements such as the various examples of functionality 204 described herein are improvements to computing technology. People manifestly lack the speed and the digital communication and computation capabilities which are required to perform functionality 204 operations as taught herein.

Different embodiments provide different technical benefits or other advantages in different circumstances, but one of skill informed by the teachings herein will acknowledge that particular technical advantages will likely follow from particular embodiment features or feature combinations, as noted at various points herein.

Any generic or abstract aspects of described embodiments are integrated into a practical application, such as an integrated development environment 122, an AI-based assistant which includes an interface to a language model, or a language model 220 itself. The foregoing are examples, not a comprehensive list of all potential practical applications of the present disclosure's teachings.

Many embodiments are suitable for implementation in a single device, but some embodiments also span multiple devices.

Some embodiments described herein may be viewed by some people in a broader context. For instance, concepts such as efficiency, reliability, redundancy, or waste may be deemed pertinent to a particular embodiment. However, it does not follow from the availability of a broad context that exclusive rights are being sought herein for abstract ideas; they are not. In particular, no claim is made to data extraction activities generally, or translation activities generally, or assistive (accessibility) technologies generally, as opposed to the particular functionality 204 methods, systems, and devices described and claimed in the eventual final claims based on the present disclosure.

Rather, the present disclosure is focused on providing appropriately specific embodiments whose technical effects fully or partially solve particular technical problems noted herein, e.g., in connection with one of the marker phrases “how to”, “problem”, or “challenge”, or otherwise apparent to one of skill in the art. Other systems, devices, and processes involving efficiency, reliability, redundancy, or waste are outside the present scope. Accordingly, vagueness, mere abstractness, lack of technical character, and accompanying proof problems are also avoided under a proper understanding of the present disclosure.

### Additional Combinations and Variations

Any combination of logic, components, communications, software, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, examples, operating environments, tools, peripherals, process flows, identifiers, naming conventions, notations, control flows, data flows, or other implementation choices described or used herein. Any apparent conflict with any other patent disclosure, even from the owner of the present subject matter, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
ASCII: American Standard Code for Information Interchange
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
LAN: local area network
MAC: media access control
OS: operating system
PaaS or PAAS: platform-as-a-service
RAM: random access memory
ROM: read only memory
TPU: tensor processing unit
UEFI: Unified Extensible Firmware Interface
UTF: Unicode Transformation Format
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Sharing a reference numeral does not mean necessarily sharing every aspect, feature, or limitation of every item referred to using the reference numeral. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and

“software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” as a noun means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account or user session, or by software on behalf of a user, or by hardware on behalf of a user. Activity is represented by digital data or machine operations or both in a system. Activity within the scope of any claim based on the present disclosure excludes human action, but does allow coverage of computational action which is performed in response to human action. Software or hardware activity “on behalf of a user” accordingly refers to software or hardware activity on behalf of a user device or on behalf of a user account or a user session or on behalf of another mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” in a computing system is a computational entity identified by system utilities such as Windows® Task Manager, Linux® ps, or similar utilities in other operating system environments (marks of Microsoft Corporation, Linus Torvalds, respectively). “Process” may also be used as a patent law term of art, e.g., in describing a process claim as opposed to a system claim or an article of manufacture (configured storage medium) claim. Similarly, “method” is used herein primarily as a patent law term of art (akin to a “method”) but it is also a technical term in the computing science arts (a kind of “routine”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Functionality 204 operations discussed herein (whether recited expressly in the Figures or not), are understood to be inherently non-human. A human mind cannot interface directly with a computing device to perform the functionality 204 steps taught herein. This would all be well understood by persons of skill in the art in view of the present disclosure. Moreover, one of skill understands that functionality 204 cannot be implemented merely with conventional tools and steps, because actual implementation requires the use of teachings which were first provided in the present disclosure, e.g., teachings that support the recited technical effects and technical operations.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”.

“Proactively” means without a direct request from a user, and indicates machine activity rather than human activity. Indeed, a user may not even realize that a proactive step by an embodiment was possible until a result of the step has been presented to the user. Except as otherwise stated, any computational and/or automatic step described herein is presumptively done proactively in at least some of the embodiments.

“Based on” means computationally based on at least, not based exclusively on. Thus, a calculation based on X depends computationally on at least X, and may also depend computationally on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

In claims and elsewhere herein, labels such as (a), (b), etc. in a method description are meant to aid legibility of the description, not to impose a strict order or a total ordering of actions in the method. For instance, steps labeled as (a), (b), etc. for convenience may overlap in some embodiments, or interleave in some embodiments. Step performance order may nonetheless be indicated by verb tenses, or be indicated otherwise to one of skill such as when completion of one step is a practical prerequisite to another step.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in a computer system memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a computer system hardware processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational or other electronic or electrical device step on behalf of a party of interest, with regard to a destination or object, may involve intervening action, such as any action recited in this disclosure or inherent in a step recited in this disclosure, yet still be understood as being performed directly by or on behalf of the party of interest. Example verbs listed herein may overlap in meaning or even be synonyms; separate verb names do not dictate separate functionality in every case.

Some people have asserted, outside the present disclosure, that certain verbs indicate human activity, particularly human mental activity. Regardless of their accuracy in other contexts, those assertions are not a correct and accurate basis for the interpretation of any claim supported by the present disclosure, regardless of where they were made. No reference outside the present disclosure to human action associated with a given verb can provide a legally correct basis for the interpretation of any verb recited in any claim supported by the present disclosure. For example, any and all of the choosing, extracting, filtering, identifying, prompting, supplying, translating, and other embodiment actions described and claimed herein is artificial activity, not human activity.

It is well-established in patent law that proper interpretation of a claim begins with the claim itself, then looks to other claims, then seeks meaning for the claim and its limitations in view of the supporting specification, including the disclosure's text and any drawing figures, while applying the viewpoint of a person skilled in the art. To be reasonable, any claim interpretation must be consistent with the specification. Only if the meaning of claim language remains unclear after considering the claims and their supporting disclosure does it become proper to look for interpretive guidance at any use of the claim language outside the four corners of the patent application itself.

Relying on external assertions to establish that certain verbs denote human activity elsewhere and therefore also denote mental steps or other human activity within claims herein is legally incorrect. Such reliance is arbitrary and capricious when the specification clearly teaches that such human activity is outside the scope of the claims, as the current specification clearly teaches. Relying on such external assertions is also disrespectful of the efforts of patent practitioners and inventors to make it clear that human activity is not being claimed.

To the extent any human activity is arguably within the scope of any claim based on the present disclosure, that human activity scope is hereby expressly disclaimed and expressly disavowed. Human-machine interaction may be properly noted in a claim for context, e.g., when a claim recites that a user input is received by a computing system. But only the portion of the effective claim scope which is computational and supported herein by the description of computing hardware, interfaces, algorithms, data structures, and/or other non-human mechanisms, as understood by one of skill in the art, is retained.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and computer readable storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### Remarks Regarding Reference Numerals

Reference numerals are provided for convenience and in support of the drawing figures and as part of the text of the specification, which collectively describe aspects of embodiments by reference to multiple items. Items which do not have a unique reference numeral may nonetheless be part of a given embodiment. For better legibility of the text, a given reference numeral is recited near some, but not all, recitations of the referenced item in the text. The same reference numeral may be used with reference to different examples or different instances of a given item.

A list of multiple reference numerals given with an item, e.g., language similar to “item 1, 2, 3”, indicates that the item is an example of a respective category associated with each listed reference numeral. For example, “laptop 101, 102” indicates that a laptop is both a machine 101 and a computing system 102. A distinction in this example is that a computing system 102 contains one or more machines 101, whereas reference numeral 101 refers to a single machine, e.g., a single laptop, a single smartphone, a single workstation, a single Internet of Things device, etc. However, reference numerals for more general categories are often omitted herein for better readability, particularly when one of skill would acknowledge that the more general category encompasses a more specific category whose reference numeral is recited.

The following remarks pertain to particular reference numerals:
100 operating environment, also referred to as computing environment; includes one or more systems 102
101 machine in a system 102, e.g., any device having at least a processor 110 and having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor or non-empty set of processors; includes hardware
112 computer-readable storage medium, e.g., RAM, hard disks; also referred to as storage device
114 removable configured computer-readable storage medium
116 instructions executable with processor; may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers; also refers to an execution engine such as a language runtime
122 software tools, e.g., software applications, web browsers, ADSPC software, security controls; hardware tools; computational
124 cloud, also referred to as cloud environment or cloud computing environment
126 display screens, also referred to as “displays”
128 hardware, software, or hardware-software combination that is not otherwise associated with a reference numeral 106, 108, 110, 112, 114, e.g., power supply, application program interface (API), network interface
202 enhanced system, i.e., system 102 enhanced with functionality 204 as taught herein
204 ADSPC functionality (also referred to as functionality 204 and other terms associated with reference numeral 204), e.g., a mechanism which performs or is configured to perform steps 226 (extracting) and 228 (translating), or steps 302 (filtering, with either or both of 304, 306) and 228 (translating), or steps 226 (extracting) and 602 (supplying), or steps 302 (filtering, with either or both of 304, 306) and 602 (supplying), or any mechanism which performs or is configured to perform a sequence of accessibility information selection activities first disclosed herein, or a sequence of prompt context construction activities first disclosed herein, or to perform a novel method 800 first disclosed herein
216 interface, e.g., network interface card, API, user interface, language model interface, or other mechanism by or through which separable items communicate in a computing system, where examples of separable include physically separable, separately compilable, separately installable, or separably replaceable without loss of functionality
308 markdown language, e.g., John Gruber's Markdown from 2004 and subsequent versions to at least the priority date of the present disclosure, CommonMark, variants discussed in Request for Comments 7764, Markdown Extra; although markup languages are not commonly referred to as markdown languages, markdown language 308 herein also includes Extensible Markup Language (XML), Standard Generalized Markup Language (SGML), Yet Another Markup Language (YAML), HTML, and other markup languages if markdown language is expressly stated in a claim to include markup language; unless stated expressly as including markup language(s), “markdown language” excludes markup languages
442 text style, e.g., bold, underline, italic, superscript, subscript
600 flowchart; 600 also refers to ADSPC methods that are illustrated by or consistent with the FIG. 6 flowchart or any variation of the FIG. 6 flowchart described herein
700 flowchart; 700 also refers to ADSPC methods that are illustrated by or consistent with the FIG. 7 flowchart or any variation of the FIG. 7 flowchart described herein
800 flowchart; 800 also refers to ADSPC methods that are illustrated by or consistent with the FIG. 8 flowchart or any variation of the FIG. 8 flowchart described herein; the FIG. 8 flowchart, which incorporates the flowcharts of FIG. 6 and FIG. 7, the steps implicit or express in FIGS. 1 through 5, and all other steps taught herein, or methods that are illustrated by or consistent with any variation of the FIG. 8 flowchart described herein; all ADSPC method steps are computational or otherwise artificial, not human activity
854 any step or item discussed in the present disclosure that has not been assigned some other reference numeral; 854 may thus be shown expressly as a reference numeral for various steps or items or both, and may properly be inserted as a reference numeral (in the current disclosure or any subsequent patent application which claims priority to the current disclosure) for various steps or items or both without thereby adding new matter

### CONCLUSION

Some embodiments get 852 accessibility information 136 of a web page 134, and then filter 302 it to include specified context data 522 and to exclude specified non-context data 406. A version of the context data is provided to a language model 220 in a prompt 222, or along with a prompt, to influence computation 838 of a response 512 of the language model. In some cases, the provided version includes a markdown language 308 translation 228 of accessibility data 206 extracted from the web page. Some embodiments run 806 a browser script 492 before extracting the accessibility data. In some, a portion of the markdown text 310 is chosen 814, with the choice being based on vector similarity 508 or on association with an anchor link 458, 500 or a skip-to link 470, 500. In some embodiments, links 500 are consolidated 810.

Embodiments are understood to also themselves include or benefit from tested and appropriate security controls and privacy controls such as the General Data Protection Regulation (GDPR), and to comply with all applicable laws and regulations, e.g., the European Union Artificial Intelligence Act (EU AI Act) when applicable. Use of the tools and techniques taught herein can be done together with such controls in compliance with such laws and regulations.

Although Microsoft technology is used in some examples, the teachings herein are not limited to use in technology supplied or administered by Microsoft. Under a suitable license, for example, the present teachings could be embodied in products or services provided by other vendors.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific details, such as specific thresholds, topologies, system architectures, and specific operating environments, and thus need not appear in every embodiment. Those of skill will also understand that component identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such a standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A method performed by a computing system, the method comprising:
extracting accessibility data by extracting structure data or content data, or both, from accessibility information of a web page, the extracting comprising filtering such that the extracted accessibility data is free of text display data which specifies a visual display characteristic of a text string;
translating at least a part of the extracted accessibility data into a markdown language text; and
supplying at least a portion of the markdown language text to a language model as a prompt context.

2. The method of claim 1, wherein the computing system comprises a web browser and a script in the web browser, and the method further comprises:
altering or creating accessibility data by running the script prior to the extracting.

3. The method of claim 1, wherein the translating comprises at least one of:
mapping a hypertext markup language element role structure data to a markdown component; or
consolidating multiple links into a single link.

4. The method of claim 1, wherein the extracting comprises at least one of:
reading a hidden text of the web page; or
filtering such that the extracted accessibility data is free of at least four of:
style sheet data, display color data, color contrast data, text style data, text font data, text size data, header data, footer data, or web page display icon data.

5. The method of claim 1, further comprising choosing the portion of the markdown language text, and the choosing comprises at least one of:
performing a vector similarity comparison of a markdown vector which is derived from the markdown language text to a user query vector which is derived from a user query, and choosing in response to a result of the vector similarity comparison; or
identifying a section of the web page which is associated with an anchor link or a skip-to link, and choosing markdown language text which corresponds to the identified section.

6. The method of claim 1, wherein the extracting comprises filtering such that the extracted accessibility data comprises at least four of: heading structure data, heading content data, hypertext markup language element role structure data, hypertext markup language landmark structure data, hypertext markup language element semantic structure data, anchor link structure data, skip-to content link structure data, webform placeholder structure data, closed captioning content data, video transcript content data, audio transcript content data, image alternative text description content data, link name description content data, image content data, or form label content data.

7. A computing system, comprising:
a digital memory;
a processor in operable communication with the digital memory;
an accessibility data extraction procedure comprising instructions which upon execution by the processor extracts accessibility data by extracting structure data or content data, or both, from accessibility information of a web page, the extracting comprising filtering such that the extracted accessibility data is free of text color data and free of background color data;
an accessibility data translation procedure comprising instructions which upon execution by the processor translates at least a part of the extracted accessibility data into a markdown language text; and
an interface to a language model prompt generation tool, the interface configured to receive at least a portion of the markdown language text.

8. The computing system of claim 7, wherein the accessibility data extraction procedure comprises instructions which upon execution by the processor filter data such that the extracted accessibility data comprises at least six of: heading structure data, heading content data, hypertext markup language element role structure data, hypertext markup language landmark structure data, hypertext markup language element semantic structure data, anchor link structure data, skip-to content link structure data, webform placeholder structure data, closed captioning content data, video transcript content data, audio transcript content data, image alternative text description content data, link name description content data, image content data, or form label content data.

9. The computing system of claim 7, wherein the accessibility data extraction procedure comprises instructions which upon execution by the processor check for and filter out at least two of: hypertext markup language element role structure data of a presentation role, hypertext markup language element role structure data of a widget role, hypertext markup language element role structure data of a live region role, or hypertext markup language element role structure data of a window role.

10. The computing system of claim 7, wherein the accessibility data translation procedure comprises instructions which upon execution by the processor map at least one of the following hypertext markup language element role structure data to a markdown component: heading, paragraph, list, link, image, blockquote, code, equation, or table.

11. The computing system of claim 7, wherein the accessibility data extraction procedure comprises instructions which upon execution by the processor check for and filter out at least four of: style sheet data, display color data, color contrast data, text style data, text font data, text size data, header data, footer data, or web page display icon data.

12. The computing system of claim 7, wherein the accessibility data extraction procedure comprises instructions which upon execution by the processor check for and filter out each of: text color data, and background color data.

13. The computing system of claim 7, wherein the accessibility data extraction procedure comprises instructions which upon execution by the processor check for and filter out each of: text style data, text font data, and text size data.

14. The computing system of claim 7, wherein the accessibility data extraction procedure comprises instructions which upon execution by the processor check for and filter out each of: header data, and footer data.

15. The computing system of claim 7, wherein the accessibility data extraction procedure comprises instructions which upon execution by the processor check for and filter out web page display icon data.

16. A computer-readable storage medium configured with data and instructions which upon execution by a processor of a computing system perform a method, the method comprising:
extracting accessibility data by extracting structure data or content data, or both, from accessibility information of a web page, the extracting comprising filtering such that the extracted accessibility data is free of text color data and free of text font data;
translating at least a part of the extracted accessibility data into a markdown language text; and
supplying at least a portion of the markdown language text to a language model as a prompt context.

17. The computer-readable storage medium of claim 16, wherein the translating comprises mapping a hypertext markup language element role structure data to a markdown component.

18. The computer-readable storage medium of claim 16, wherein the translating comprises consolidating multiple links into a single link.

19. The computer-readable storage medium of claim 16, wherein the extracting comprises getting a version of accessibility data from a screen reader assistive technology mechanism, and then filtering the version of accessibility data by checking for and filtering out at least three of: style sheet data, text color data, background color data, text style data, text font data, text size data, footer data, or web page display icon data.

20. The computer-readable storage medium of claim 16, wherein the extracting comprises getting a version of accessibility data from a client uniform resource locator tool, and then filtering the version of accessibility data by checking for and filtering out at least three of: style sheet data, text color data, background color data, text style data, text font data, text size data, footer data, or web page display icon data.
